(19) United States
(12) Patent Application Publication
(10) Pub. No.: US 2024/0298676 A1
(43) Pub. Date: Sep. 12, 2024

(54) USE OF ENZYMES AND FIBER TO OPTIMIZE SENSORIAL PROCESSING PROPERTIES DURING MANUFACTURE OF BOTANICAL BEVERAGES

(71) Applicant: PASTORE ORGANICS AMERICAS INC., Trappe, PA (US)

(72) Inventors: William R. AIMUTIS, Denver, NC (US); Joseph HILDEBRAND, Concord, NC (US); Kenny OYEFARA, Philadelphia, PA (US); Sola OYEFARA, Philadelphia, PA (US)

(21) Appl. No.: 18/182,003

(22) Filed: Mar. 10, 2023

(51) Int. Cl. A23L 2/84; A23L 2/02; A23L 2/56

(52) U.S. Cl. CPC A23L 2/84; A23L 2/02; A23L 2/56; C12Y 302/01001

(57) ABSTRACT

A botanical beverage formulation include an enzyme-hydrolyzed tiger nut beverage at a quantity of 90% to 99% by weight of the total botanical beverage formulation and at least one soluble fiber at a quantity of 0.1% to 8% by weight of the total botanical beverage formulation.

### FIELD OF INVENTION

The present disclosure relates generally to systems and methods for producing botanical beverages and, more particularly, to systems and methods for using enzymes and soluble fibers to produce botanical beverages.

### BACKGROUND OF THE INVENTION

Mouthfeel is a food product's physical and chemical interactions in the mouth used to describe the overall texture of a food product or a beverage. When human subjects ingest a food product or beverage, they subconsciously monitor the entire process from initial bite, through mastication to swallowing. The mouth is an extremely sophisticated processing device enabling both feedback and feedforward sensing. A desirable mouthfeel attribute of beverages is the sensory sensation “creamy mouthfeel” or “creaminess” which has been reported to be related to multiple food properties, including smoothness, thickness, and specific flavors.

Creaminess appears to be related to a combination of several factors, including (i) moderate to high viscosity, (ii) non-Newtonian flow, (iii) presence of some fat, and (iv) other factors including use of other ingredients. However, to maintain a clean-label, low fat product that consumers find creamy, it would be advantageous to leverage physical properties present in a food formulation without addition of other ingredients or increasing the fat level. Lubricity is also commonly used to describe mouthfeel sensations that mimic higher fat products.

To analytically understand the mechanisms of creamy perception, multidisciplinary approaches of fracture and failure, rheology, tribology and forensic microscopy are now used. Rheological measurements are especially convenient for measuring thickness of a beverage, but do not adequately predict the creamy mouthfeel often described by humans for fuller fat products that are being orally processed.

### SUMMARY OF THE INVENTION

The summary is a high-level overview of various aspects of the invention and introduces some of the concepts that are further detailed in the Detailed Description section below. This summary is not intended to identify key or essential features of the claimed subject matter, nor is it intended to be used in isolation to determine the scope of the claimed subject matter. The subject matter should be understood by reference to the appropriate portions of the entire specification, any or all drawings, and each claim.

Embodiments of the present disclosure relate to a botanical beverage formulation including an enzyme-hydrolyzed tiger nut beverage at a quantity of 90% to 99% by weight of the total botanical beverage formulation and at least one soluble fiber at a quantity of 0.1% to 8% by weight of the total botanical beverage formulation.

In some embodiments, the soluble fiber is at least one of maple fiber, psyllium, tree fibers, crystalline cellulose, modified cellulose fiber, pectin or resistant starch.

In some embodiments, the formulation also includes a flavoring at a range of 0.1% to 10% by weight of the total botanical beverage formula, where the flavoring includes at least one of cocoa, vanilla, fruit purees or other flavorant.

In some embodiments, the present disclosure relates to a method including mixing a tiger nut substrate with water to form a tiger nut beverage; filtering the tiger nut beverage to form a filtered tiger nut beverage; combining the tiger nut beverage with an enzyme and a cofactor to form an unhydrolyzed tiger nut beverage, where the enzyme is present at a quantity of 0.005% to 0.3% by weight of the total tiger nut beverage; stirring the unhydrolyzed tiger nut beverage at a sufficient temperature and time to form an enzyme-hydrolyzed tiger nut beverage; heating the enzyme-hydrolyzed tiger nut beverage for a sufficient temperature to denature the enzyme and form a botanical beverage.

In some embodiments, the method further includes combining the unhydrolyzed tiger nut beverage with a soluble fiber, where the soluble fiber is present at a quantity of 0.1% to 8% by weight.

In some embodiments, the enzyme is a hydrolase enzyme.

In some embodiments, the enzyme is amylase.

In some embodiments, the enzyme is bacterial-sourced amylase.

In some embodiments, the cofactor is a calcium salt.

In some embodiments, the cofactor is at least one of calcium chloride, calcium carbonate, calcium hydroxide, calcium acetate, calcium gluconate, calcium lactate or calcium citrate.

In some embodiments, the soluble fiber is at least one of maple fiber, psyllium, tree fibers, crystalline cellulose, modified cellulose fiber, pectin or resistant starch.

In some embodiments, the method further includes adding a flavoring to the botanical beverage, where the flavoring includes at least one of cocoa, vanilla, fruit purees or other flavorant.

In some embodiments, the tiger nut substrate is in a form of tiger nut flour.

In some embodiments, the water is present at a quantity of 10% to 20% of the tiger nut beverage.

In some embodiments, the unhydrolyzed tiger nut beverage is stirred at a temperature of 70° C. to 85° C.

In some embodiments, the unhydrolyzed tiger nut beverage is stirred for 20 min to 40 min.

In some embodiments, the enzyme-hydrolyzed tiger nut beverage is heated at a temperature of 85° C. to 105° C.

In some embodiments, the enzyme-hydrolyzed tiger nut beverage is heated for 5 min to 10 min.

In some embodiments, the cofactor is present at a quantity of 280 parts per million to 325 parts per million in the beverage.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the present disclosure.

FIG. 1 is a graph depicting the lubricity of enzymes, according to exemplary embodiments of the present disclosure.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. It will be understood that various changes may be made in the function and arrangement of elements without departing from the spirit and scope of the presently disclosed embodiments. Embodiment examples are described as follows with reference to the FIGURES. Identical, similar, or identically acting elements in the various FIGURES are identified with identical reference numbers and a repeated description of these elements is omitted in part to avoid redundancies.

Consumer pressure on the food industry to provide more plant-based alternatives to animal-based products has fueled interest in botanical beverages. Generally, these beverages have been extracts from tree nuts (e.g., almonds, cashews, coconuts, etc.), oil seeds (e.g., soy), or other grains (e.g., oats, rice, etc.). Food scientists continue to explore other plant-based materials to produce botanical beverages to improve flavor, mouthfeel, and nutrition. Tubers have also begun emerging for use in botanical beverages. These later substrates usually present issues after processing as starches found in the botanicals undergo gelation and/or separation a short period of time after products are formulated and heat processed using pasteurization or sterilization temperatures.

Prior art has demonstrated that enzyme preparations containing alpha amylase, beta amylase, hemicellulose, cellulase, and pectinase singularly or in combination can improve processability of botanicals and offer shelf-stability against gelation. However, prior art does not mention using enzymes in a very controlled manner (specific pH, temperature, concentration, cofactors, and reaction time) to improve mouthfeel.

In some embodiments, the present disclosure relates to a system and method for producing a botanical beverage with improved mouthfeel, processability and shelf stability. In some embodiments, a botanical beverage is a plant-based beverage. In some embodiments, the botanical beverage includes an enzyme-hydrolyzed tiger nut beverage. As used herein, “enzyme-hydrolyzed tiger nut beverage” is defined as a tiger nut beverage in which enzymes facilitate the cleavage of bonds in molecules with the addition of the elements of water (i.e. hydrolysis). In some embodiments, an enzyme is used at a temperature below its optimum activity and in the presence of a cofactor to impact processability, shelf stability, and mouthfeel of the tiger nut botanical beverage. In some embodiments, a soluble fiber is used in the botanical beverage to enable formulation and control of viscosity in plant-based beverages.

In some embodiments, the enzyme is from the hydrolase class of enzymes. In some embodiments, the enzyme is amylase. In some embodiments, the enzyme is a bacterial-sourced amylase. In some embodiments, the enzyme is alpha amylase. In some embodiments, the alpha amylase is from Bacillus amyloliquefaciens; Novozymes BAN 480L.

In some embodiments, the substrate is tiger nuts. Tiger nuts, also known as chufa, yellow nutsedge, or earth almonds, are edible tubers. In some embodiments, the tiger nuts are in the form of whole tiger nuts, tiger nut flour, tiger nut milk, tiger nut butter or any other form. In some embodiments, the tiger nuts may be black tiger nuts, brown tiger nuts or yellow tiger nuts. In some embodiments, the tiger nuts may be dried, roasted or raw.

In some embodiments, the tiger nut flour has an average particle size of 150 microns. In some embodiments, the tiger nut flour has an average particle size of 50 microns to 300 microns. In some embodiments, the tiger nut flour has an average particle size of 100 microns to 300 microns. In some embodiments, the tiger nut flour has an average particle size of 150 microns to 300 microns. In some embodiments, the tiger nut flour has an average particle size of 200 microns to 300 microns. In some embodiments, the tiger nut flour has an average particle size of 250 microns to 300 microns.

In some embodiments, the tiger nut flour has an average particle size of 50 microns to 250 microns. In some embodiments, the tiger nut flour has an average particle size of 50 microns to 200 microns. In some embodiments, the tiger nut flour has an average particle size of 50 microns to 150 microns. In some embodiments, the tiger nut flour has an average particle size of 50 microns to 100 microns.

In some embodiments, the tiger nut flour has an average particle size of 100 microns to 200 microns. In some embodiments, the tiger nut flour has an average particle size of 150 microns to 200 microns. In some embodiments, the tiger nut flour has an average particle size of 200 microns to 250 microns. In some embodiments, the tiger nut flour has an average particle size of 100 microns to 150 microns.

In some embodiments, the enzyme to substrate ratio is 0.073-0.0012%.

In some embodiments, the botanical beverage is produced using enzyme hydrolysis. In some embodiments, the mouthfeel of the botanical beverage is improved by enzymatic treatment of the botanical beverage, prior to thermal treatment, to microbially stabilize the beverage. For example, in some embodiments, a method for producing the botanical beverage includes: mixing a tiger nut substrate with water to form a tiger nut beverage; combining the tiger nut beverage with an enzyme and a cofactor to form an unhydrolyzed tiger nut beverage; stirring the unhydrolyzed tiger nut beverage at a sufficient temperature and time to form an enzyme-hydrolyzed tiger nut beverage; and heating the hydrolyzed tiger nut beverage for a sufficient temperature and time to denature the enzyme and form a botanical beverage.

In some embodiments, the method for producing the botanical beverage also includes a filtering step after combining the tiger nut flour with the water to remove insoluble particles that are larger than desired. In some embodiments, the filtering step removes excessive insoluble fines and tiger nut pieces.

In some embodiments, the method also includes fortifying the botanical beverage with the soluble fiber.

In some embodiments, the method includes pasteurizing the botanical beverage.

In some embodiments, the botanical beverage includes the substrate at a quantity of 17% to 99%. In some embodiments, the botanical beverage includes the substrate at a quantity of 20% to 99%. In some embodiments, the botanical beverage includes the substrate at a quantity of 25% to 99%. In some embodiments, the botanical beverage includes the substrate at a quantity of 40% to 99%. In some embodiments, the botanical beverage includes the substrate at a quantity of 50% to 99%. In some embodiments, the botanical beverage includes the substrate at a quantity of 60% to 99%. In some embodiments, the botanical beverage includes the substrate at a quantity of 75% to 99%. In some embodiments, the botanical beverage includes the substrate at a quantity of 80% to 99%.

In some embodiments, the botanical beverage includes the substrate at a quantity of 17% to 80%. In some embodiments, the botanical beverage includes the substrate at a quantity of 17% to 75%. In some embodiments, the botanical beverage includes the substrate at a quantity of 17% to 60%. In some embodiments, the botanical beverage includes the substrate at a quantity of 17% to 50%. In some embodiments, the botanical beverage includes the substrate at a quantity of 17% to 40%. In some embodiments, the botanical beverage includes the substrate at a quantity of 17% to 25%. In some embodiments, the botanical beverage includes the substrate at a quantity of 17% to 20%.

In some embodiments, the botanical beverage includes the substrate at a quantity of 30% to 80%. In some embodiments, the botanical beverage includes the substrate at a quantity of 45% to 75%. In some embodiments, the botanical beverage includes the substrate at a quantity of 55% to 60%. In some embodiments, the botanical beverage includes the substrate at a quantity of 25% to 50%. In some embodiments, the botanical beverage includes the substrate at a quantity of 65% to 40%. In some embodiments, the botanical beverage includes the substrate at a quantity of 70% to 85%. In some embodiments, the botanical beverage includes the substrate at a quantity of 85% to 95%.

In some embodiments, the water is present in a quantity of 10% to 20% of the tiger nut beverage. In some embodiments, the water is present in a quantity of 12% to 20% of the tiger nut beverage. In some embodiments, the water is present in a quantity of 14% to 20% of the tiger nut beverage. In some embodiments, the water is present in a quantity of 16% to 20% of the tiger nut beverage. In some embodiments, the water is present in a quantity of 18% to 20% of the tiger nut beverage.

In some embodiments, the water is present in a quantity of 10% to 18% of the tiger nut beverage. In some embodiments, the water is present in a quantity of 10% to 16% of the tiger nut beverage. In some embodiments, the water is present in a quantity of 10% to 14% of the tiger nut beverage. In some embodiments, the water is present in a quantity of 10% to 12% of the tiger nut beverage.

In some embodiments, the water is present in a quantity of 12% to 18% of the tiger nut beverage. In some embodiments, the water is present in a quantity of 12% to 16% of the tiger nut beverage. In some embodiments, the water is present in a quantity of 12% to 14% of the tiger nut beverage. In some embodiments, the water is present in a quantity of 14% to 18% of the tiger nut beverage. In some embodiments, the water is present in a quantity of 14% to 16% of the tiger nut beverage. In some embodiments, the water is present in a quantity of 16% to 18% of the tiger nut beverage.

In some embodiments, the botanical beverage formulation includes the enzyme at a quantity of 0.005% to 0.3% by weight. In some embodiments, the botanical beverage formulation includes the enzyme at a quantity of 0.01% to 0.3% by weight. In some embodiments, the botanical beverage formulation includes the enzyme at a quantity of 0.05% to 0.3% by weight. In some embodiments, the botanical beverage formulation includes the enzyme at a quantity of 0.1% to 0.3% by weight. In some embodiments, the botanical beverage formulation includes the enzyme at a quantity of 0.15% to 0.3% by weight. In some embodiments, the botanical beverage formulation includes the enzyme at a quantity of 0.2% to 0.3% by weight. In some embodiments, the botanical beverage formulation includes the enzyme at a quantity of 0.25% to 0.3% by weight.

In some embodiments, the botanical beverage formulation includes the enzyme at a quantity of 0.005% to 0.3% by weight. In some embodiments, the botanical beverage formulation includes the enzyme at a quantity of 0.005% to 0.25% by weight. In some embodiments, the botanical beverage formulation includes the enzyme at a quantity of 0.005% to 0.2% by weight. In some embodiments, the botanical beverage formulation includes the enzyme at a quantity of 0.005% to 0.15% by weight. In some embodiments, the botanical beverage formulation includes the enzyme at a quantity of 0.005% to 0.1% by weight. In some embodiments, the botanical beverage formulation includes the enzyme at a quantity of 0.005% to 0.05% by weight. In some embodiments, the botanical beverage formulation includes the enzyme at a quantity of 0.005% to 0.01% by weight.

In some embodiments, the botanical beverage formulation includes the enzyme at a quantity of 0.01% to 0.25% by weight. In some embodiments, the botanical beverage formulation includes the enzyme at a quantity of 0.05% to 0.25% by weight. In some embodiments, the botanical beverage formulation includes the enzyme at a quantity of 0.2% to 0.25% by weight. In some embodiments, the botanical beverage formulation includes the enzyme at a quantity of 0.1% to 0.15% by weight. In some embodiments, the botanical beverage formulation includes the enzyme at a quantity of 0.015% to 0.1% by weight. In some embodiments, the botanical beverage formulation includes the enzyme at a quantity of 0.01% to 0.05% by weight. In some embodiments, the botanical beverage formulation includes the enzyme at a quantity of 0.1% to 0.2% by weight.

In some embodiments, the enzyme has a hydrolysis temperature of 50° C. to 95° C. In some embodiments, the enzyme has a hydrolysis temperature of 55° C. to 95° C. In some embodiments, the enzyme has a hydrolysis temperature of 60° C. to 95° C. In some embodiments, the enzyme has a hydrolysis temperature of 65° C. to 95° C. In some embodiments, the enzyme has a hydrolysis temperature of 70° C. to 95° C. In some embodiments, the enzyme has a hydrolysis temperature of 75° C. to 95° C. In some embodiments, the enzyme has a hydrolysis temperature of 80° C. to 95° C. In some embodiments, the enzyme has a hydrolysis temperature of 90° C. to 95° C.

In some embodiments, the enzyme has a hydrolysis temperature of 50° C. to 90° C. In some embodiments, the enzyme has a hydrolysis temperature of 50° C. to 85° C. In some embodiments, the enzyme has a hydrolysis temperature of 50° C. to 80° C. In some embodiments, the enzyme has a hydrolysis temperature of 50° C. to 75° C. In some embodiments, the enzyme has a hydrolysis temperature of 50° C. to 70° C. In some embodiments, the enzyme has a hydrolysis temperature of 50° C. to 65° C. In some embodiments, the enzyme has a hydrolysis temperature of 50° C. to 60° C. In some embodiments, the enzyme has a hydrolysis temperature of 50° C. to 55° C.

In some embodiments, the enzyme has a hydrolysis temperature of 55° C. to 90° C. In some embodiments, the enzyme has a hydrolysis temperature of 60° C. to 90° C. In some embodiments, the enzyme has a hydrolysis temperature of 80° C. to 90° C. In some embodiments, the enzyme has a hydrolysis temperature of 85° C. to 90° C. In some embodiments, the enzyme has a hydrolysis temperature of 70° C. to 85° C. In some embodiments, the enzyme has a hydrolysis temperature of 75° C. to 85° C. In some embodiments, the enzyme has a hydrolysis temperature of 80° C. to 85° C. In some embodiments, the enzyme has a hydrolysis temperature of 60° C. to 80° C. In some embodiments, the enzyme has a hydrolysis temperature of 60° C. to 80° C. In some embodiments, the enzyme has a hydrolysis temperature of 65° C. to 80° C. In some embodiments, the enzyme has a hydrolysis temperature of 70° C. to 80° C. In some embodiments, the enzyme has a hydrolysis temperature of 75° C. to 80° C. In some embodiments, the enzyme has a hydrolysis temperature of 80° C. to 85° C.

In some embodiments, the activity of the enzyme is improved by the presence of a cofactor. In some embodiments, the cofactor is a calcium salt. In some embodiments, the cofactor includes at least one of calcium carbonate, calcium chloride, calcium hydroxide, calcium acetate, calcium gluconate, calcium lactate or calcium citrate.

In some embodiments, the botanical beverage formulation includes the cofactor at a quantity of 180 parts per million. In some embodiments, the botanical beverage formulation includes the cofactor at a quantity of 50 to 325 parts per million. In some embodiments, the botanical beverage formulation includes the cofactor at a quantity of 100 to 325 parts per million. In some embodiments, the botanical beverage formulation includes the cofactor at a quantity of 150 to 325 parts per million. In some embodiments, the botanical beverage formulation includes the cofactor at a quantity of 200 to 325 parts per million. In some embodiments, the botanical beverage formulation includes the cofactor at a quantity of 250 to 325 parts per million.

In some embodiments, the botanical beverage formulation includes the cofactor at a quantity of 50 to 250 parts per million. In some embodiments, the botanical beverage formulation includes the cofactor at a quantity of 50 to 200 parts per million. In some embodiments, the botanical beverage formulation includes the cofactor at a quantity of 50 to 150 parts per million. In some embodiments, the botanical beverage formulation includes the cofactor at a quantity of 50 to 100 parts per million.

In some embodiments, the botanical beverage formulation includes the cofactor at a quantity of 100 to 200 parts per million. In some embodiments, the botanical beverage formulation includes the cofactor at a quantity of 150 to 200 parts per million. In some embodiments, the botanical beverage formulation includes the cofactor at a quantity of 100 to 250 parts per million. In some embodiments, the botanical beverage formulation includes the cofactor at a quantity of 100 to 150 parts per million. In some embodiments, the botanical beverage formulation includes the cofactor at a quantity of 150 to 250 parts per million. In some embodiments, the botanical beverage formulation includes the cofactor at a quantity of 200 to 250 parts per million.

In some embodiments, the unhydrolyzed tiger nut beverage is stirred at a sufficient temperature and time to form an enzyme-hydrolyzed tiger nut beverage. In some embodiments, the unhydrolyzed tiger nut beverage is stirred at a temperature of 80° C. In some embodiments, the unhydrolyzed tiger nut beverage is stirred at a temperature of 70° C. to 85° C. In some embodiments, the unhydrolyzed tiger nut beverage is stirred at a temperature of 75° C. to 85° C. In some embodiments, the unhydrolyzed tiger nut beverage is stirred at a temperature of 80° C. to 85° C. In some embodiments, the unhydrolyzed tiger nut beverage is stirred at a temperature of 70° C. to 80° C. In some embodiments, the unhydrolyzed tiger nut beverage is stirred at a temperature of 70° C. to 75° C. In some embodiments, the unhydrolyzed tiger nut beverage is stirred at a temperature of 75° C. to 80° C.

In some embodiments, at the stirring temperature, limited cleavage of the starch glucose backbone occurs because the enzyme is only 40% active. In some embodiments, at the stirring temperature, the enzyme is only 25% to 60% active. In some embodiments, at the stirring temperature, the enzyme is only 30% to 60% active. In some embodiments, at the stirring temperature, the enzyme is only 35% to 60% active. In some embodiments, at the stirring temperature, the enzyme is only 40% to 60% active. In some embodiments, at the stirring temperature, the enzyme is only 45% to 60% active. In some embodiments, at the stirring temperature, the enzyme is only 50% to 60% active. In some embodiments, at the stirring temperature, the enzyme is only 55% to 60% active.

In some embodiments, at the stirring temperature, the enzyme is only 25% to 55% active. In some embodiments, at the stirring temperature, the enzyme is only 25% to 50% active. In some embodiments, at the stirring temperature, the enzyme is only 25% to 45% active. In some embodiments, at the stirring temperature, the enzyme is only 25% to 40% active. In some embodiments, at the stirring temperature, the enzyme is only 25% to 35% active. In some embodiments, at the stirring temperature, the enzyme is only 25% to 30% active.

In some embodiments, at the stirring temperature, the enzyme is only 30% to 55% active. In some embodiments, at the stirring temperature, the enzyme is only 35% to 50% active. In some embodiments, at the stirring temperature, the enzyme is only 40% to 45% active. In some embodiments, at the stirring temperature, the enzyme is only 35% to 40% active. In some embodiments, at the stirring temperature, the enzyme is only 50% to 55% active. In some embodiments, at the stirring temperature, the enzyme is only 30% to 45% active. In some embodiments, at the stirring temperature, the enzyme is only 30% to 35% active.

In some embodiments, the unhydrolyzed tiger nut beverage is stirred for 30 minutes. In some embodiments, the unhydrolyzed tiger nut beverage is stirred for 20 min to 40 min. In some embodiments, the unhydrolyzed tiger nut beverage is stirred for 25 min to 40 min. In some embodiments, the unhydrolyzed tiger nut beverage is stirred for 30 min to 40 min. In some embodiments, the unhydrolyzed tiger nut beverage is stirred for 35 min to 40 min.

In some embodiments, the unhydrolyzed tiger nut beverage is stirred for 20 min to 35 min. In some embodiments, the unhydrolyzed tiger nut beverage is stirred for 20 min to 30 min. In some embodiments, the unhydrolyzed tiger nut beverage is stirred for 20 min to 25 min.

In some embodiments, the unhydrolyzed tiger nut beverage is stirred for 25 min to 35 min. In some embodiments, the unhydrolyzed tiger nut beverage is stirred for 25 min to 30 min. In some embodiments, the unhydrolyzed tiger nut beverage is stirred for 30 min to 35 min.

In some embodiments, the pH of the formulation is 6.7. In some embodiments, the pH of the formulation is 4.5 to 7.5. In some embodiments, the pH of the formulation is 5.0 to 7.5. In some embodiments, the pH of the formulation is 5.5 to 7.5. In some embodiments, the pH of the formulation is 6.0 to 7.5. In some embodiments, the pH of the formulation is 6.5 to 7.5.

In some embodiments, the pH of the enzyme-hydrolyzed tiger nut beverage is 4.5 to 7.0. In some embodiments, the pH of the enzyme-hydrolyzed tiger nut beverage is 5.0 to 6.5. In some embodiments, the pH of the enzyme-hydrolyzed tiger nut beverage is 4.5 to 6.0. In some embodiments, the pH of the enzyme-hydrolyzed tiger nut beverage is 4.5 to 5.5. In some embodiments, the pH of the enzyme-hydrolyzed tiger nut beverage is 4.5 to 5.0.

In some embodiments, the pH of the enzyme-hydrolyzed tiger nut beverage is 5.0 to 7.0. In some embodiments, the pH of the enzyme-hydrolyzed tiger nut beverage is 5.0 to 6.5. In some embodiments, the pH of the enzyme-hydrolyzed tiger nut beverage is 5.5 to 7.0. In some embodiments, the pH of the enzyme-hydrolyzed tiger nut beverage is 5.0 to 5.5. In some embodiments, the pH of the enzyme-hydrolyzed tiger nut beverage is 6.0 to 6.5. In some embodiments, the pH of the enzyme-hydrolyzed tiger nut beverage is 6.5 to 7.0. In some embodiments, the pH of the enzyme-hydrolyzed tiger nut beverage is 5.0 to 6.0. In some embodiments, the pH of the enzyme-hydrolyzed tiger nut beverage is 5.5 to 6.0. In some embodiments, the pH of the enzyme-hydrolyzed tiger nut beverage is 5.5 to 6.5. In some embodiments, the pH of the enzyme-hydrolyzed tiger nut beverage is 6.0 to 6.5.

In some embodiments, the enzyme-hydrolyzed tiger nut beverage is heated for a sufficient temperature and time to denature the enzyme, forming a botanical beverage. In some embodiments, the enzyme denaturation is performed because excessive starch hydrolysis causes a loss of mouthfeel and an increasingly sweet, finished product. In some embodiments, the enzyme-hydrolyzed tiger nut beverage is heated to 95° C. In some embodiments, the enzyme-hydrolyzed tiger nut beverage is heated to 85° C. to 105° C. In some embodiments, the enzyme-hydrolyzed tiger nut beverage is heated to 90° C. to 105° C. In some embodiments, the enzyme-hydrolyzed tiger nut beverage is heated to 95° C. to 105° C. In some embodiments, the enzyme-hydrolyzed tiger nut beverage is heated to 100° C. to 105° C.

In some embodiments, the enzyme-hydrolyzed tiger nut beverage is heated to 85° C. to 100° C. In some embodiments, the enzyme-hydrolyzed tiger nut beverage is heated to 85° C. to 95° C. In some embodiments, the enzyme-hydrolyzed tiger nut beverage is heated to 85° C. to 90° C.

In some embodiments, the enzyme-hydrolyzed tiger nut beverage is heated to 90° C. to 100° C. In some embodiments, the enzyme-hydrolyzed tiger nut beverage is heated to 90° C. to 95° C. In some embodiments, the enzyme-hydrolyzed tiger nut beverage is heated to 95° C. to 100° C.

In some embodiments, the enzyme-hydrolyzed tiger nut beverage is heated for 10 minutes. In some embodiments, the enzyme-hydrolyzed tiger nut beverage is heated for 5 min to 15 min. In some embodiments, the enzyme-hydrolyzed tiger nut beverage is heated for 10 min to 15 min. In some embodiments, the enzyme-hydrolyzed tiger nut beverage is heated for 5 min to 10 min.

In some embodiments, the botanical beverage may include added flavoring. In some embodiments, the botanical beverage may be flavored using, for example, cocoa, vanilla, fruit purees or other flavorant. In some embodiments, the botanical beverage formulation includes the flavorant at a quantity of 0.1% to 10% by weight. In some embodiments, the botanical beverage formulation includes the flavorant at a quantity of 1% to 10% by weight. In some embodiments, the botanical beverage formulation includes the flavorant at a quantity of 2% to 10% by weight. In some embodiments, the botanical beverage formulation includes the flavorant at a quantity of 4% to 10% by weight. In some embodiments, the botanical beverage formulation includes the flavorant at a quantity of 6% to 10% by weight. In some embodiments, the botanical beverage formulation includes the flavorant at a quantity of 8% to 10% by weight.

In some embodiments, the botanical beverage formulation includes the flavorant at a quantity of 0.1% to 8% by weight. In some embodiments, the botanical beverage formulation includes the flavorant at a quantity of 1% to 6% by weight. In some embodiments, the botanical beverage formulation includes the flavorant at a quantity of 2% to 4% by weight. In some embodiments, the botanical beverage formulation includes the flavorant at a quantity of 4% to 2% by weight. In some embodiments, the botanical beverage formulation includes the flavorant at a quantity of 6% to 1% by weight.

In some embodiments, the botanical beverage formulation includes the flavorant at a quantity of 1% to 5% by weight. In some embodiments, the botanical beverage formulation includes the flavorant at a quantity of 1% to 2% by weight. In some embodiments, the botanical beverage formulation includes the flavorant at a quantity of 2% to 6% by weight. In some embodiments, the botanical beverage formulation includes the flavorant at a quantity of 4% to 8% by weight. In some embodiments, the botanical beverage formulation includes the flavorant at a quantity of 6% to 8% by weight. In some embodiments, the botanical beverage formulation includes the flavorant at a quantity of 2% to 4% by weight. In some embodiments, the botanical beverage formulation includes the flavorant at a quantity of 5% to 6% by weight. In some embodiments, the botanical beverage formulation includes the flavorant at a quantity of 1% to 8% by weight.

In some embodiments, a soluble fiber may be added to the botanical beverage to improve the mouthfeel of the botanical beverage. In some embodiments, the soluble fiber is added to the botanical beverage prior to pasteurization. In some embodiments, the soluble fiber includes, but is not limited to, at least one of psyllium, tree fibers, crystalline cellulose, modified cellulose fiber, pectin, resistant starch or maple fiber. Maple fiber is unique because it is a relatively simple molecule, like microcrystalline cellulose, and generally exists in a crystalline form. Furthermore, when heated in the presence of proteins, the viscosity increases a slight amount. By controlling the maple fiber concentrations, a person skilled in the art would be able to fine tune the finished beverage viscosity.

In some embodiments, the soluble fiber is used at low concentrations such as, for example, 0.1% to 8% by weight of the total formulation to control the final viscosity of the botanical beverage. In some embodiments, the total formulation includes soluble fiber at a quantity of 0.5% to 8% by weight. In some embodiments, the total formulation includes soluble fiber at a quantity of 1% to 8% by weight. In some embodiments, the total formulation includes soluble fiber at a quantity of 2% to 8% by weight. In some embodiments, the total formulation includes soluble fiber at a quantity of 3% to 8% by weight. In some embodiments, the total formulation includes soluble fiber at a quantity of 4% to 8% by weight. In some embodiments, the total formulation includes soluble fiber at a quantity of 5% to 8% by weight. In some embodiments, the total formulation includes soluble fiber at a quantity of 6% to 8% by weight. In some embodiments, the total formulation includes soluble fiber at a quantity of 7% to 8% by weight.

In some embodiments, the total formulation includes soluble fiber at a quantity of 0.1% to 7% by weight. In some embodiments, the total formulation includes soluble fiber at a quantity of 0.1% to 6% by weight. In some embodiments, the total formulation includes soluble fiber at a quantity of 0.1% to 5% by weight. In some embodiments, the total formulation includes soluble fiber at a quantity of 3% to 8% by weight. In some embodiments, the total formulation includes soluble fiber at a quantity of 0.1% to 4% by weight. In some embodiments, the total formulation includes soluble fiber at a quantity of 0.1% to 3% by weight. In some embodiments, the total formulation includes soluble fiber at a quantity of 0.1% to 2% by weight. In some embodiments, the total formulation includes soluble fiber at a quantity of 0.1% to 1% by weight. In some embodiments, the total formulation includes soluble fiber at a quantity of 0.1% to 0.5% by weight.

In some embodiments, the total formulation includes soluble fiber at a quantity of 0.01% to 0.02% by weight. In some embodiments, the total formulation includes soluble fiber at a quantity of 0.01% to 0.015% by weight. In some embodiments, the total formulation includes soluble fiber at a quantity of 0.015% to 0.02% by weight. In some embodiments, the total formulation includes soluble fiber at a quantity of 3% to 8% by weight. In some embodiments, the total formulation includes soluble fiber at a quantity of 0.1% to 4% by weight. In some embodiments, the total formulation includes soluble fiber at a quantity of 2% to 3% by weight. In some embodiments, the total formulation includes soluble fiber at a quantity of 2% to 7% by weight. In some embodiments, the total formulation includes soluble fiber at a quantity of 0.5% to 7% by weight. In some embodiments, the total formulation includes soluble fiber at a quantity of 6% to 7% by weight.

In some embodiments, other soluble fibers such as, for example, inulin, oat, and others, may be used to build viscosity in beverages. However, in these embodiments, higher levels of the soluble fibers may be used.

In some embodiments, the botanical beverage may be pasteurized to form a pasteurized botanical beverage. In some embodiments, the botanical beverage may be pasteurized at a temperature of 63° C. to 154° C. In some embodiments, the botanical beverage may be pasteurized at a temperature of 75° C. to 154° C. In some embodiments, the botanical beverage may be pasteurized at a temperature of 100° C. to 154° C. In some embodiments, the botanical beverage may be pasteurized at a temperature of 125° C. to 154° C. In some embodiments, the botanical beverage may be pasteurized at a temperature of 150° C. to 154° C.

In some embodiments, the botanical beverage may be pasteurized at a temperature of 63° C. to 150° C. In some embodiments, the botanical beverage may be pasteurized at a temperature of 63° C. to 125° C. In some embodiments, the botanical beverage may be pasteurized at a temperature of 63° C. to 100° C. In some embodiments, the botanical beverage may be pasteurized at a temperature of 63° C. to 75° C.

In some embodiments, the botanical beverage may be pasteurized at a temperature of 63° C. to 72° C. In some embodiments, the botanical beverage may be pasteurized at a temperature of 72° C. to 135° C. In some embodiments, the botanical beverage may be pasteurized at a temperature of 135° C. to 154° C.

In some embodiments, the botanical beverage may be pasteurized for 1 second to 30 minutes. In some embodiments, the botanical beverage may be pasteurized for 3 seconds to 30 minutes. In some embodiments, the botanical beverage may be pasteurized for 15 seconds to 30 minutes. In some embodiments, the botanical beverage may be pasteurized for 1 minute to 30 minutes. In some embodiments, the botanical beverage may be pasteurized for 5 minutes to 30 minutes. In some embodiments, the botanical beverage may be pasteurized for 10 minutes to 30 minutes. In some embodiments, the botanical beverage may be pasteurized for 15 minutes to 30 minutes.

In some embodiments, the botanical beverage may be pasteurized for 1 second to 15 minutes. In some embodiments, the botanical beverage may be pasteurized for 1 second to 10 minutes. In some embodiments, the botanical beverage may be pasteurized for 1 second to 5 minutes. In some embodiments, the botanical beverage may be pasteurized for 1 second to 1 minute. In some embodiments, the botanical beverage may be pasteurized for 1 second to 30 seconds. In some embodiments, the botanical beverage may be pasteurized for 1 second to 15 seconds. In some embodiments, the botanical beverage may be pasteurized for 1 second to 3 seconds.

In some embodiments, the botanical beverage may be pasteurized for 3 seconds to 5 seconds. In some embodiments, the botanical beverage may be pasteurized for 1 minute to 10 minutes. In some embodiments, the botanical beverage may be pasteurized for 5 minutes to 25 minutes. In some embodiments, the botanical beverage may be pasteurized for 20 minutes to 25 minutes. In some embodiments, the botanical beverage may be pasteurized for 15 second to 1 minute. In some embodiments, the botanical beverage may be pasteurized for 3 seconds to 15 seconds. In some embodiments, the botanical beverage may be pasteurized for 15 minutes to 20 minutes.

In some embodiments, the botanical beverage may be used in a barista mil. In some embodiments, when used in a barista milk, the base botanical beverage is present in a quantity of 95% to 99.5%. In some embodiments, the botanical beverage is present in a quantity of 96% to 99.5%. In some embodiments, the botanical beverage is present in a quantity of 97% to 99.5%. In some embodiments, the botanical beverage is present in a quantity of 98% to 99.5%. In some embodiments, the botanical beverage is present in a quantity of 99% to 99.5%.

In some embodiments, the botanical beverage is present in a quantity of 95% to 99%. In some embodiments, the botanical beverage is present in a quantity of 95% to 98%. In some embodiments, the botanical beverage is present in a quantity of 95% to 97%. In some embodiments, the botanical beverage is present in a quantity of 95% to 96%.

In some embodiments, the botanical beverage is present in a quantity of 96% to 99%. In some embodiments, the botanical beverage is present in a quantity of 96% to 98%. In some embodiments, the botanical beverage is present in a quantity of 96% to 97%. In some embodiments, the botanical beverage is present in a quantity of 97% to 99%. In some embodiments, the botanical beverage is present in a quantity of 97% to 98%. In some embodiments, the botanical beverage is present in a quantity of 98% to 99%.

### EXAMPLES

In the following examples, mouthfeel of the disclosed botanical beverage was quantified using a human sensory panel, rotational viscometry, and tribological instrumentation. Results are cited below as examples.

### Example 1: Control Beverage

Fresh tiger nut tubers were sorted, washed, and rinsed with filtered water. The cleaned tiger nuts were then submerged in water, heated to 77° C., and held for 60 minutes to soften the tubers. After draining, tiger nuts (20.45 Kg) were submerged in filtered water (74.625 Kg) in a Bredo Likwifier. The tiger nuts were milled for 15 minutes. The resulting tiger nut beverage was then filtered through a 50-mesh bag to remove unmilled and partially milled tiger nuts. The tiger nut beverage was then passed through 24-mesh and 50-mesh screens to remove fines. The beverage was diluted with filtered water to 12% solids. Following dilution, the tiger nut beverage was homogenized at 2000/500 psi in a double pass followed by pasteurization at 118° C. for 30 seconds. The tiger nut beverage was then bottled and stored at 4° C.

In some embodiments, an alternative method can be used to manufacture tiger nut beverage. For example, in some embodiments, tiger nut flour (average particle size is ˜ 150 microns) (12.5 Kg) can replace whole tiger nuts noted earlier to eliminate the sorting, washing, and heating steps. All subsequent steps remained the same.

### Example 2: Enzyme Hydrolyzed Beverage

Blanched tiger nuts (20.45 Kg) or tiger nut flour (12.5 Kg) were submerged in filtered water (74.625 Kg) in a Bredo Likwifier. The tiger nuts were milled for 15 minutes. The resulting tiger nut beverage was then filtered through a 50-mesh bag to remove unmilled and partially milled tiger nuts. The tiger nut beverage was then passed through 24-mesh and 50-mesh screens to remove fines. The tiger nut beverage was diluted with filtered water to 12% solids. The resulting filtered tiger nut beverage was then inoculated with alpha amylase. The enzyme concentration range of the alpha amylase was 0.0001 or 0.0012% based on tiger nut physical state (whole vs. flour, respectively). Additionally, a calcium source in the form of a nutritional pre-mix or as inorganic compounds (for example, calcium carbonate) was added at 220-350 ppm Ca (preferably 280-325 ppm calcium ions) to the filtered tiger nut beverage to form an unhydrolyzed tiger nut beverage. The unhydrolyzed tiger nut beverage was then gently stirred and held at a temperature of approximately 80° C. for 30 minutes to form an enzyme-hydrolyzed tiger nut beverage. This temperature is 10-20° C. lower than the optimal temperature of the alpha amylase enzyme system. In some embodiments, a tiger nut beverage may be determined to be enzyme-hydrolyzed by comparing the starch pasting property of the unhydrolyzed tiger nut beverage to the starch pasting property of the enzyme-hydrolyzed tiger nut beverage using a rotational visco analyzer. For example, in some embodiments, the peak viscosity of the tiger nut beverage may decrease with increasing enzyme digestion. After one hour, the enzyme-hydrolyzed tiger nut beverage was heated to 95° C. for 10 minutes to inactivate the alpha amylase enzyme and cooled back to 35° C. to form a botanical beverage. The botanical beverage was homogenized at 2000/500 psi in a double pass followed by pasteurization at 118° C. for 30 seconds. The pasteurized botanical beverage was then bottled and stored at 4°.

### Example 3. Fiber Fortified Hydrolyzed Beverage

Fiber is often deficient in the human diet. While tiger nuts have some fiber associated with the tuber, the level of fiber in the tiger nut beverage formulations of Examples 1 and 2 would not meet the definition of a “good source of fiber”. Therefore, a tiger nut flour beverage created according to Example 2 was treated with enzymes to form an botanical beverage and was supplemented with fiber (0-8%, preferably 4.5%) immediately prior to the pasteurization step to form a fiber-fortified botanical beverage. Maple fiber was selected to fortify the tiger nut beverage, but also to determine if there was an effect on texture, specifically mouthfeel.

### Example 4: Human Sensory Evaluation of Beverages

A sensory trial was performed using untrained panelists to evaluate the texture of the tiger nut beverage manufactured with and without enzymes. An additional variable was included that contained maple fiber. Specifically, the sensory trial was performed to determine if enzyme treatment and fiber fortification would impact the mouthfeel of the tiger nut beverage. Three variables were served to the panelists including: a control tiger nut beverage, enzyme hydrolyzed tiger nut milk, and a fiber fortified tiger nut milk. Twelve panelists were asked to score flavor, mouthfeel, and overall liking using a 1 (dislike) to 7 (extremely liked) hedonic scale. Mean data from the sensory panel is presented in Table 1 below:

TABLE 1

| | Sensory Variable | | |
|---|---|---|---|
| | | | Overall |
| Sample: | Flavor | Mouthfeel | Liking |
| Control Beverage | 5.8 | 5.5 | 5.5 |
| Enzyme Hydrolyzed Beverage | 6.0 | 5.9 | 5.9 |
| Fiber Fortified Hydrolyzed Beverage | 5.9 | 6.3 | 6.1 |

Panelists positively commented there was noticeably more lubricity in the fiber fortified hydrolyzed beverage than the control beverage and the enzyme hydrolyzed beverage, but also observed a slight off-flavor due to the maple fiber concentration used in the fiber fortified hydrolyzed beverage. Panelists also felt that the enzyme hydrolyzed beverage and the fiber fortified hydrolyzed beverage were slightly sweeter than the control beverage.

### Example 5: Textural Differences in Enzyme Treated Tiger Nut Beverage

All three beverages from Example 4 were instrumentally tested to confirm the mouthfeel observations detected by human sensory analysis. For these tests rotational viscosity was used to measure thickness. Rotational viscosity was evaluated using a Brookfield DV++ viscometer run at 23° C. using spindle 2 and recording the absolute viscosity values (in centipoise) at 100, 60, 20, 10, and 5 rpm for the control, enzyme hydrolyzed, and fiber fortified beverages. The data was then plotted and a linear regression was used to determine the intrinsic viscosity (viscosity at 0 stress on the liquid being measured). The intrinsic viscosity values for the control beverage, the enzyme hydrolyzed beverage, and fiber fortified hydrolyzed beverage were 42, 55, and 68 centipoise, respectively. These values indicate each beverage beyond the control increased in viscosity and was confirmed by the sensory panelists as increased mouthfeel due to thickness.

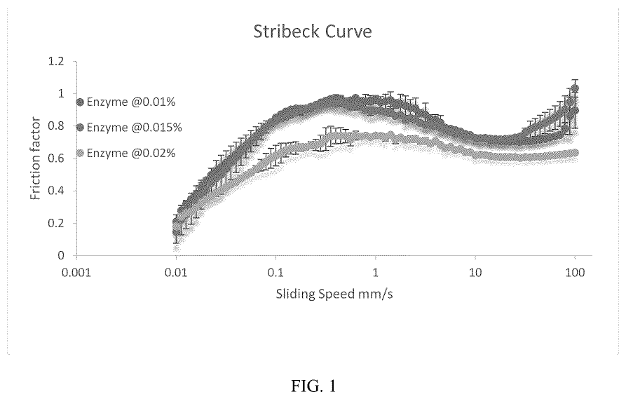

Enzyme concentration optimization was determined using tribology which measures lubricity. Testing was done using a T-PTD 200, BC12.7 tribology cell, mounted on a Physica MCR 302 rheometer (Anton Paar). Parameters were set at an axial force of 2 Newtons, the normal force was 0.94 Newtons, sliding speed was 100-0.01 mm/second, and the sliding ramp method used was stepwise. Samples studied were a tiger nut beverage hydrolyzed with enzyme concentrations of 0.01, 0.015, and 0.02%. Stribeck curves indicated the optimized enzyme concentration for the best lubricity (and therefore mouthfeel) was 0.015%. As noted in FIG. 1, 0.02% may have hydrolyzed the amylose starch chains too far and resulting in reduced mouthfeel. Further confirmation was observed when the same samples were tested with rotational viscometry. The intrinsic viscosity for the 0.01, 0.015, and 0.2% beverages were 78, 54, and 37 centipoise, respectively. The intrinsic viscosity for the 0.015% enzyme concentration was very close to the earlier rotational viscosity study noted above. Intrinsic viscosity of enzyme treated tiger nut milk was more viscous than water. The Stribeck curves analytically indicated tiger nut beverage provided more lubricity than control samples. The interpretation of the data set in its entirety shows the creamy mouthfeel perceived by sensory panelists was analytically substantiated by rotational viscometry and tribology.

The disclosure of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

1. A botanical beverage formulation comprising:
an enzyme-hydrolyzed tiger nut beverage at a quantity of 90% to 99% by weight of the total botanical beverage formulation; and
at least one soluble fiber at a quantity of 0.1% to 8% by weight of the total botanical beverage formulation.

2. The botanical beverage formulation of claim 1, wherein the soluble fiber is at least one of maple fiber, psyllium, tree fibers, crystalline cellulose, modified cellulose fiber, pectin or resistant starch.

3. The botanical beverage formulation of claim 1, further comprising a flavoring at a range of 0.1% to 10% by weight of the total botanical beverage formula, wherein the flavoring comprises at least one of cocoa, vanilla, fruit purees or other flavorant.

4. The botanical beverage formulation of claim 1, further comprising a flavoring, wherein the flavoring comprises at least one of cocoa, vanilla, fruit purees or other flavorant.

5. A method, comprising:
mixing a tiger nut substrate with water to form a tiger nut beverage,
wherein the tiger nut substrate is present at a quantity of 12% to 15% by weight of the tiger nut beverage;
filtering the tiger nut beverage to form a filtered tiger nut beverage;
combining the filtered tiger nut beverage with an enzyme and a cofactor to form an unhydrolyzed tiger nut beverage,
wherein the cofactor comprises at least one of calcium/magnesium/manganese chloride, calcium hydroxide, calcium acetate, calcium gluconate, calcium lactate, or calcium citrate,
wherein the cofactor is present at a quantity of 280 ppm to 325 ppm by weight of the unhydrolyzed tiger nut beverage,
wherein the enzyme comprises an amylase,
wherein the enzyme is present at a quantity of 0.01% to 0.03% by weight of the unhydrolyzed tiger nut beverage;
stirring the unhydrolyzed tiger nut beverage at a sufficient temperature and time to form an enzyme-hydrolyzed tiger nut beverage; and
heating the enzyme-hydrolyzed tiger nut beverage for a sufficient temperature to denature the enzyme and form a botanical beverage,
wherein the botanical beverage has an intrinsic viscosity of 40 centipoise to 100 centipoise.

6. The method of claim 5, further comprising combining the unhydrolyzed tiger nut beverage with a soluble fiber, wherein the soluble fiber is present at a quantity of 0.1% to 8% by weight.

7.-8. (canceled)

9. The method of claim 5, wherein the enzyme is bacterial-sourced amylase.

10. The method of claim 5, wherein the cofactor is a calcium salt.

11. (canceled)

12. The method of claim 6, wherein the soluble fiber is at least one of maple fiber, psyllium, tree fibers, crystalline cellulose, modified cellulose fiber, pectin or resistant starch.

13. The method of claim 5, further comprising a flavoring, wherein the flavoring comprises at least one of cocoa, vanilla, fruit purees or other flavorant.

14. The method of claim 5, wherein the tiger nut substrate is in a form of tiger nut flour.

15. (canceled)

16. The method of claim 5, wherein the unhydrolyzed tiger nut beverage is stirred at a temperature of 70° C. to 85° C.

17. The method of claim 5, wherein the unhydrolyzed tiger nut beverage is stirred for 20 min to 40 min.

18. The method of claim 5, wherein the enzyme-hydrolyzed tiger nut beverage is heated at a temperature of 85° C. to 105° C.

19. The method of claim 5, wherein the enzyme-hydrolyzed tiger nut beverage is heated for 5 min to 10 min.

20. (canceled)
